(19) United States
(12) Patent Application Publication
(10) Pub. No.: US 2012/0158412 A1
(43) Pub. Date: Jun. 21, 2012

(54) Identification of Contact Mode for Contacting Parties to Maximize the Probability of Achieving a Desired Outcome

(75) Inventors: Chitra Dorai, Chappaqua, NY (US); Eric R. Ray, Bloomfield Hills, MI (US); Gary L. Seybold, Weddington, NC (US); Anshul Sheopuri, White Plains, NY (US)

(73) Assignee: INTERNATIONAL BUSINESS MACHINES CORPORATION, Armonk, NY (US)

(21) Appl. No.: 12/969,094

(22) Filed: Dec. 15, 2010

(51) Int. Cl. G06F 17/30; G06Q 10/00

(52) U.S. Cl. 705/1.1; 707/737; 707/E17.089

(57) ABSTRACT

Computer implemented method, data processing system, and computer readable storage medium having computer program product encoded thereon for identifying a contact mode for contacting parties to maximize a probability of achieving a desired outcome. A plurality of parties are divided into a plurality of clusters of parties according to a list of attributes that are statistically significant with respect to achieving a desired outcome. A subset of parties from each cluster of parties of the plurality of clusters of parties are selected, and parties in each subset of parties are contacted by different ones of a plurality of contact modes. A result of the contacting for each subset of parties is analyzed to identify a contact mode of the plurality of contact modes for contacting the parties in each cluster of the plurality of clusters that maximizes a probability of achieving the desired outcome.

### BACKGROUND

1. Field

The disclosure relates generally to a computer implemented method, a data processing system, and a computer readable storage medium having a computer program product encoded thereon. More specifically, the disclosure relates to a computer implemented method, a data processing system, and a computer readable storage medium having a computer program product encoded thereon for identifying a contact mode for contacting parties to maximize a probability of achieving a desired outcome.

2. Description of the Related Art

There are many situations in which an entity may have an interest in contacting parties in an effort to achieve a desired outcome. For example, in the mortgage industry, it may be desirable for a lender to contact borrowers that are determined to be at risk of defaulting on a mortgage loan to discuss modifying the mortgage loan in an effort to prevent the default. Also, during a marketing campaign, a company may wish to contact customers in an effort to sell a product. In addition, during a political campaign, a political party may wish to contact registered voters to obtain contributions or to convince the voters to vote for a particular candidate. Yet further, many governmental activities require contacting citizens in an effort to achieve a desired outcome. Examples of such governmental activities may include issuing health advisories or conducting a census of the population.

There are many different ways to contact a party. For example, the party may be contacted by sending an e-mail to the party's home or office, by calling the party on his/her home phone, work phone or cell phone, by texting (SMS) or by sending the party a letter.

It is known, however, that different parties may react differently to different contact modes. For example, differences in work hours or other lifestyle constraints may lead some parties to prefer one contact mode over another. It would be desirable, therefore, to be able to identify contact modes for contacting different parties in order to maximize a probability of achieving a desired outcome.

Current efforts to determine contact preferences include performing in-market surveys using questionnaires. Such surveys, however, are often biased and thus preclude informed decision making. Also, many parties may not respond to such surveys, and, often, the parties not responding are those most in need of being contacted. Other efforts to determine contact preferences include contacting parties by all available outreach modes simultaneously and observing the responses. This approach, however, has been found to be unduly costly to both the contacting entity and to the parties being contacted, and is generally impractical.

### SUMMARY

According to one embodiment of the present invention, a computer implemented method, a data processing system, and a computer readable storage medium having a computer program product encoded thereon are provided for identifying a contact mode for contacting parties to maximize a probability of achieving a desired outcome. A data processing system divides a plurality of parties into a plurality of clusters of parties according to a list of attributes that are statistically significant with respect to achieving a desired outcome. The data processing system selects a subset of parties from each cluster of parties of the plurality of clusters of parties, and contacts parties in each subset of parties by different ones of a plurality of contact modes. The data processing system analyzes a result of the contacting for each subset of parties to identify a contact mode of the plurality of contact modes for contacting the parties in each cluster of the plurality of clusters that maximizes a probability of achieving the desired outcome.

### BRIEF DESCRIPTION OF THE SEVERAL VIEWS OF THE DRAWINGS

FIG. 1 is an illustration that depicts a pictorial representation of a network of data processing systems in which illustrative embodiments may be implemented;

FIG. 2 is an illustration of a block diagram of a data processing system in accordance with an illustrative embodiment;

FIG. 3 is an illustration of a block diagram depicting an apparatus for identifying a contact mode for contacting parties to maximize a probability of achieving a desired outcome in accordance with an illustrative embodiment; and

FIG. 4 is an illustration of a flowchart depicting a process for identifying a contact mode for contacting parties to maximize a probability of achieving a desired outcome in accordance with an illustrative embodiment.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

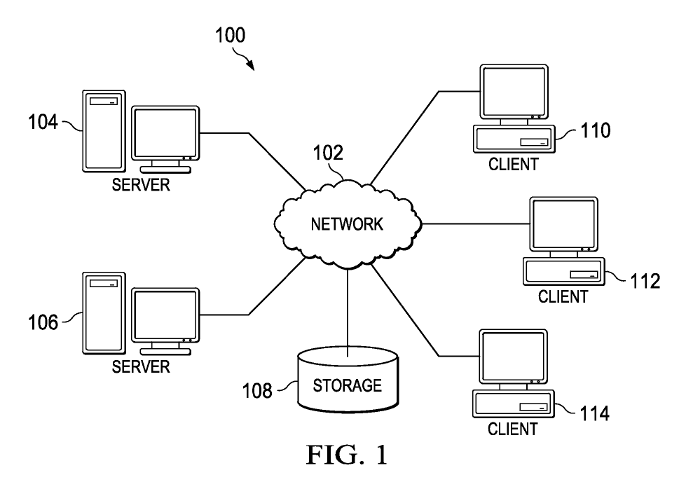

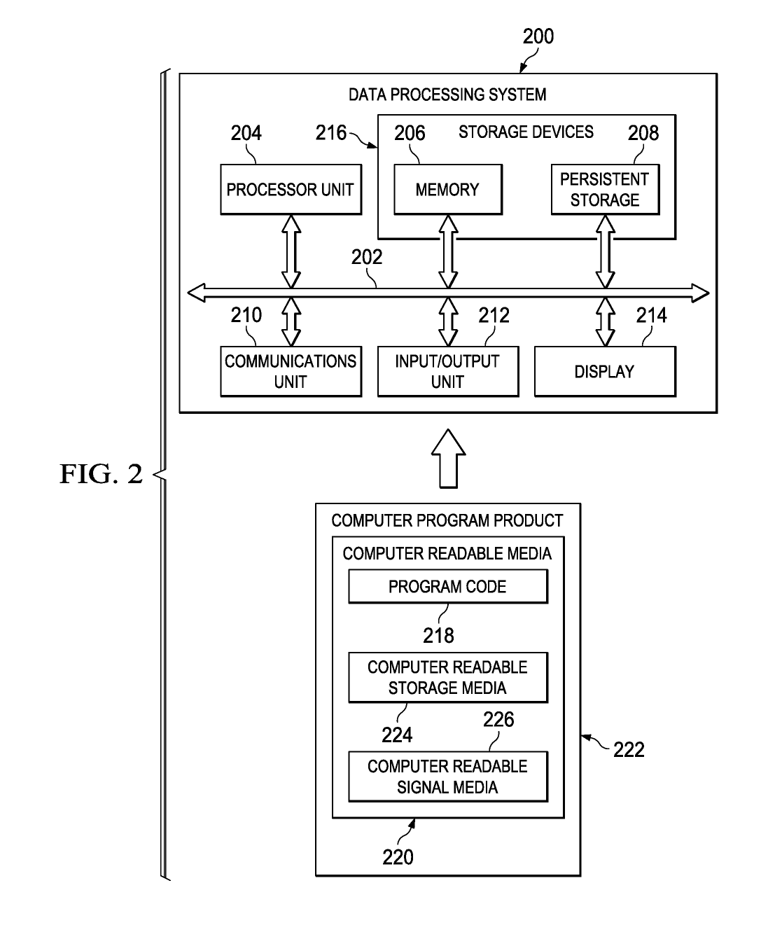

With reference now to the figures, and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is an illustration that depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides information, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an illustration that depicts a diagram of a data processing system in accordance with an illustrative embodiment. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory, or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code, in the different embodiments, may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communications links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system through computer readable signal media 226 for use within data processing system 200. For instance, program code stored in a computer readable storage media in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Illustrative embodiments provide a computer implemented method, a data processing system, and a computer readable storage medium having a computer program product encoded thereon for identifying a contact mode for contacting parties to maximize a probability of achieving a desired outcome. In accordance with an illustrative embodiment, a data processing system divides a plurality of parties into a plurality of clusters of parties according to a list of attributes that are statistically significant with respect to achieving a desired outcome. The data processing system selects a subset of parties from each cluster of parties of the plurality of clusters of parties, and contacts parties in each subset of parties by different ones of a plurality of contact modes. The data processing system analyzes a result of the contacting for each subset of parties to identify a contact mode of the plurality of contact modes for contacting the parties in each cluster of the plurality of clusters that maximizes a probability of achieving the desired outcome.

In some illustrative embodiments described herein, the parties are borrowers and the desired outcome is preventing a default on a loan, for example, a mortgage loan. It should be understood, however, that it is not intended to limit illustrative embodiments to any particular parties or to any particular desired outcome. For example, in other illustrative embodiments, the parties may be customers and the desired outcome may be to sell a product or service to the customers. In still other illustrative embodiments, the parties may be registered voters and the desired outcome may be to obtain votes or contributions for a particular candidate or the parties may be citizens and the desired outcome may be for a governmental agency to advise the citizens of a health hazard or to obtain census information.

In accordance with illustrative embodiments, it is recognized that different parties may be more accessible and may react more favorably to a particular contact mode than to another contact mode. For example, a senior citizen may be more accessible and may react more favorably to a telephone call, whereas a teenager may be more accessible and may react more favorably to texting (SMS). Similarly, a party that travels frequently may be more accessible and may react more favorably to a cell phone call or an e-mail, whereas a party who is usually at home may be more accessible and may react more favorably to a telephone call to his/her home phone.

Illustrative embodiments identify a contact mode for contacting parties in order to maximize a probability of achieving a desired outcome utilizing a “multi-arm bandit” framework. Consider, for example, a bandit having multiple arms n numbered 1, 2, . . . n. Consider also that each arm represents a different on-line advertisement, for example, a beer ad, a sport shoe ad, a high end t-shirt ad, etc., and that the customer population targeted by the ads is homogeneous (i.e., the customers are similar). Let μ1, μ2 μ3, . . . μn be the likelihood that a customer would respond to an arm i, which is not known to the manager of the advertising system. Although the purchase probabilities (the likelihood that a customer will respond to an arm) are not known, they can be estimated by observing the purchase decisions of the customers that arrive one at a time, and the ad that has the highest purchase probability or reward (the highest μi) can be determined.

In accordance with illustrative embodiments, the multi-arm bandit framework is applied to determine a contact mode for contacting parties to maximize a probability of achieving a desired outcome. For example, consider that the parties are borrowers, that the desired outcome is to avoid a default on a mortgage loan, and that it is desired to identify a contact mode for contacting each borrower that will maximize the probability of achieving the desired outcome. For example, the lender may wish to contact borrowers who have been determined to be at risk of defaulting on their mortgage loans in order to propose modifications to their mortgage loans. In accordance with an illustrative embodiment, each arm of the multi-arm bandit represents a different contact mode, for example, an e-mail to a party's home, an email to a party's work, an SMS text to a cell phone, a call to a party's cell phone, a call to a party's work phone or a call to a party's home phone.

Illustrative embodiments provide a hierarchical exploration-exploitation approach with a plurality of groups or clusters of borrowers, a priori unknown. A list of attributes that are statistically significant with respect to a party defaulting on a mortgage loan is generated or otherwise provided. Examples of statistically significant attributes may include, for example, a borrower's income, the geographical area of the borrower's home, the borrower's credit score, etc. The list of attributes may then be ranked based on the importance of the attributes. The ranking may be determined, for example, based on variables that are statistically significant for determining the likelihood of the borrower defaulting on the mortgage loan, using, for example, logistic regression. The ranked list can then be used as an input to a technique for determining the clusters.

Once the list of attributes is provided, parties are assigned to each listing in the list according to the attributes of the parties. For example, if an attribute on the list is income, those parties having a high income may be grouped together in a first cluster while those parties having a lower income may be grouped together in a second cluster. Similarly, if age is an attribute on the list, those parties being at or above a particular age may be grouped together in a cluster while those parties below the particular age may be grouped together in another cluster.

An experiment is then performed to identify the contact mode for contacting the parties in each cluster that maximizes the probability of achieving the desired result (i.e., to avoid a default on the mortgage loan in this illustrative embodiment). The experiment may take various forms. In one illustrative embodiment, a random but representative subset of the population of each cluster may be selected. Each party in a subset may then be approached using a different one of the various contact modes, and the outcome of the contact with respect to each party in the subset is observed. If a party does not respond to the first contact mode by which the party was approached, the party may then be approached using a second contact mode. The process may be repeated until the party responds to a contact mode or when all contact modes have been attempted. The responses of all the parties in the subset are then analyzed to determine the contact mode that best achieved the desired result for the parties in the subset, and all of the parties in the cluster associated with the subset may then be contacted using the contact mode that best achieved the desired result for the parties in the subset.

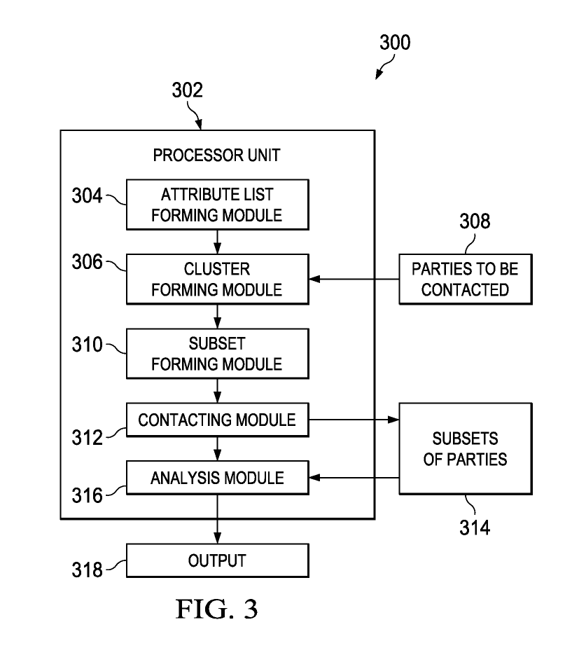

FIG. 3 is an illustration of a diagram that depicts an apparatus for identifying a contact mode for contacting parties to maximize a probability of achieving a desired outcome in accordance with an illustrative embodiment. The apparatus is generally designated by reference number 300, and includes processor unit 302 of a data processing system. Processor unit 302 may, for example, be implemented as processor unit 204 in FIG. 2.

As shown at 304 in FIG. 3, processor unit 302 may include an attribute list forming module 304 for forming a list of attributes that are to be considered, for example, attributes that are statistically significant with respect to achieving a desired outcome. Attribute list forming module may also rank the attributes in the list according to their order of importance. Processor unit 302 may also have a cluster forming module 306. Cluster forming module 306 receives, as an input, a plurality of parties to be contacted as shown at 308. Information about the parties is also input to enable the cluster forming module 306 to divide the plurality of parties into a plurality of groups or clusters according to one or more clustering techniques such as KNN, KMeans, etc.

Processor unit 302 also includes a subset forming module 310 for selecting a random but representative subset of parties from each cluster of parties of the plurality of clusters of parties. A contacting module 312 then contacts each party in each subset using a different one of a plurality of contact modes as shown at 314, and an analysis module 316 analyzes a result of the contacting for the parties in each subset of parties to identify the contact mode of the plurality of contact modes that best achieved a desired outcome for the subsets. The results of the analysis may be output as shown at 318, and all of the parties in each cluster of parties may then be contacted using the contact mode that best achieved the desired result for the parties in its associated subset of parties.

It should be recognized that the cluster forming module forms clusters of parties in a dynamic manner in that the numbers of the clusters and the attributes of the clusters may change based on the quality of the responses received from the contacts. For example, the parties belonging to the clusters and/or the cluster boundaries may change due to various factors such as the threshold for a high income may change based on market conditions. This capability assists in identifying the contact mode for contacting parties that will maximize a probability of achieving a desired outcome.

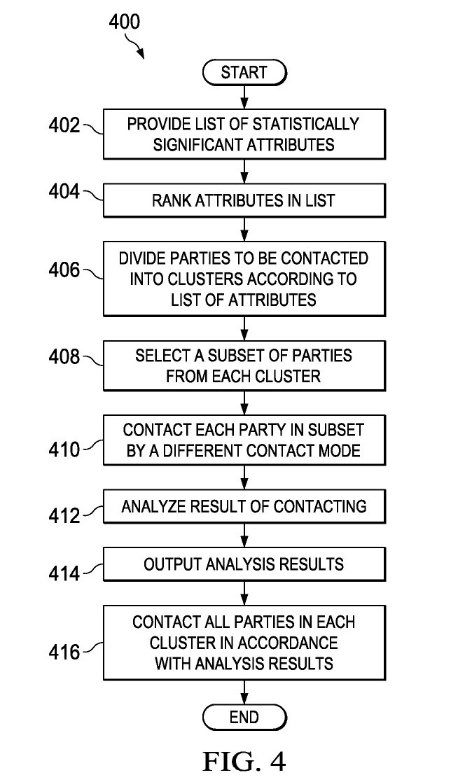

FIG. 4 is an illustration of a flowchart that depicts a process for identifying a contact mode for contacting parties to maximize a probability of achieving a desired outcome in accordance with an illustrative embodiment. The process is generally designated by reference number 400 and may begin by providing a list of attributes that are statistically significant with respect to achieving a desired result (Step 402). For example, in an illustrative embodiment wherein the parties are borrowers and the desired result is avoiding a default on a loan, the statistically significant attributes may be factors that are pertinent to a borrower deciding whether or not to default on the loan. In an illustrative embodiment wherein the parties are customers and the desired outcome is selling a product to the customers, statistically significant attributes may be those factors that are pertinent to a customer deciding whether or not to purchase the product.

The list of attributes may be ranked according to their importance to provide a ranked list of attributes (Step 404). The list may be ranked, for example, based on the variables that are statistically significant in determining likelihood of the desired outcome, using, for example, logistic regression.

A plurality of parties to be contacted is then divided into a plurality of groups or clusters according to the list of attributes (Step 406). For example, if attributes in the list of attributes includes income, the plurality of parties may be divided into a cluster that includes all parties having a high income and a cluster that includes all parties having a lower income.

A subset of the parties in each cluster of parties is then selected (Step 408). Preferably, the subsets of parties are selected randomly, but are selected to be representative of the parties in their respective clusters. The number of parties in each subset can vary depending on the accuracy requirements of an entity of interest, cost limitations and the like. Each party in the subset of parties is then contacted by a different one of a plurality of contact modes (Step 410). For example, some parties in a subset may be contacted by an SMS text, other parties of the subset by e-mail at work, and yet other parties of the subset may be contacted by cell phone, home phone or work phone. If a party does not respond to a contact mode, the party may be contacted by another contact mode, and the process repeated until the party responds to a contact mode or until all contact modes have been attempted.

The responses of each party of the subsets are observed and the observed results are then analyzed to identify the contact mode of the plurality of contact modes that best achieved the desired outcome for each subset (Step 412). The analysis may be made, for example, using support vector machine (SVM) analysis or regression analysis, and may include analyzing a quality of the response of each party that responds to the contacting.

The results of the analysis may be output (Step 414) and all of the parties in each cluster may then be contacted in accordance with the analysis results (Step 416). In particular, all of the parties in each cluster may be contacted using the contact mode that best achieved the desired outcome for the parties in its associated subset of parties to maximize the probability of achieving the desired outcome for each cluster of parties.

The analysis may also identify a second most preferred contact mode which may be used to contact parties in a cluster if the most preferred contact mode is unsuccessful.

Illustrative embodiments thus provide a computer implemented method, a data processing system, and a computer readable storage medium having a computer program product encoded thereon for identifying a contact mode for contacting parties to maximize a probability of achieving a desired outcome. A data processing system divides a plurality of parties into a plurality of clusters of parties according to a list of attributes that are statistically significant with respect to achieving a desired outcome. The data processing system selects a subset of parties from each cluster of parties of the plurality of clusters of parties, and contacts parties in each subset of parties by different ones of a plurality of contact modes. The data processing system analyzes a result of the contacting for each subset of parties to identify a contact mode of the plurality of contact modes for contacting the parties in each cluster of the plurality of clusters that maximizes a probability of achieving the desired outcome.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, ^{an} _{and} ^{the} are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for identifying a contact mode for contacting parties to maximize a probability of achieving a desired outcome, comprising:
dividing, by a data processing system, a plurality of parties into a plurality of clusters of parties according to a list of attributes that are statistically significant with respect to achieving a desired outcome;
selecting, by the data processing system, a subset of parties from each cluster of parties of the plurality of clusters of parties;
contacting, by the data processing system, parties in each subset of parties by different ones of a plurality of contact modes; and
analyzing, by the data processing system, a result of the contacting for each subset of parties to identify a contact mode of the plurality of contact modes for contacting the parties in each cluster of the plurality of clusters that maximizes a probability of achieving the desired outcome.

2. The method of claim 1, further comprising:
forming, by the data processing system, the list of attributes.

3. The method of claim 2, wherein forming the list of attributes comprises:
ranking attributes in the list of attributes according to importance of the attributes with respect to achieving the desired outcome.

4. The method of claim 3, wherein the ranking comprises ranking the attributes using logistic regression.

5. The method of claim 1, wherein selecting a subset of parties from each cluster of parties of the plurality of clusters of parties, comprises:
selecting a random but representative subset of parties from each cluster of parties.

6. The method of claim 1, wherein analyzing a result of the contacting, comprises:
analyzing the result of the contacting using one of support vector machine analysis or progression analysis.

7. The method of claim 1, wherein the plurality of contact modes comprises a plurality of a group of contact modes that includes an email to the party's home, an email to the party's office, an SMS text to the cell phone, a web chat, a telephone call to the party's cell phone, a telephone call to the party's home phone, and a telephone call to the party's work phone.

8. The method of claim 1 further comprising:
contacting the plurality of parties in each cluster of the plurality of clusters by the identified contact mode for each cluster that maximizes the probability of achieving the desired outcome.

9. The method of claim 8, wherein the dividing comprises:
changing at least one cluster of the plurality of clusters based on the contacting of the plurality of parties in each cluster of the plurality of clusters.

10. The method of claim 9, wherein changing at least one cluster, comprises:
changing the parties belonging to the at least one cluster.

11. The method of claim 1, further comprising:
responsive to a party not responding to a contact mode, the data processing system contacting the party by a different contact mode.

12. The method of claim 1, wherein the analyzing further comprises:
analyzing a result of the contacting for each subset of parties to identify a second contact mode of the plurality of contact modes for contacting the parties in each cluster of the plurality of clusters.

13. The method of claim 1, wherein the analyzing further comprises:
analyzing a quality of the response of each party that responds to the contacting.

14. The method of claim 1, wherein the plurality of parties comprises one of a plurality of borrowers at risk of defaulting on a loan or a plurality of customers, and wherein the desired outcome comprises on of preventing a default of the loan or, selling a product or service to the plurality of customers, respectively.

15. A computer program product, comprising:
a computer readable storage medium having computer program product encoded thereon for identifying a contact mode for contacting parties to maximize a probability of achieving a desired outcome, the computer program product comprising:
instructions for dividing a plurality of parties to be contacted into a plurality of clusters of parties according to a list of attributes that are statistically significant with respect to achieving a desired outcome;
instructions for selecting a subset of parties from each cluster of parties of the plurality of clusters of parties;
instructions for contacting parties in each subset of parties by different ones of a plurality of contact modes; and
instructions for analyzing a result of the contacting for each subset of parties to identify a contact mode of the plurality of contact modes for contacting the parties in each cluster of the plurality of clusters that maximizes a probability of achieving the desired outcome.

16. The computer program product of claim 15, further comprising:
instructions for forming the list of attributes.

17. The computer program product of claim 16, wherein the instructions for forming the list of attributes comprises:
instructions for ranking attributes in the list of attributes according to importance of the attributes with respect to achieving the desired outcome.

18. The computer program product of claim 15, wherein the instructions for selecting a subset of parties from each cluster of parties of the plurality of clusters of parties, comprises:
instructions for selecting a random but representative subset of parties from each cluster of parties.

19. The computer program product of claim 15, wherein the plurality of contact modes comprises a plurality of a group of contact modes that includes an email to the party's home, an email to the party's office, a telephone call to the party's cell phone, a telephone call to the party's home phone, and a telephone call to the party's work phone.

20. The computer program product of claim 15, wherein the instructions for dividing comprises:
instructions for changing clusters based on the contacting of the plurality of parties in each cluster of the plurality of clusters.

21. The computer program product of claim 15, wherein the plurality of parties comprises one of a plurality of borrowers at risk of defaulting on a loan or a plurality of customers, and wherein the desired outcome comprises one of preventing a default of the loan by the plurality of borrowers or selling a product or service to the plurality of customers.

22. An apparatus, comprising:
a bus;
a communications unit connected to the bus;
a storage device connected to the bus, wherein the storage device includes program code; and
a processor unit connected to the bus, wherein the processor unit executes the program code to:
divide a plurality of parties to be contacted into a plurality of clusters of parties according to a list of attributes that are statistically significant with respect to achieving a desired outcome;
select a subset of parties from each cluster of parties of the plurality of clusters of parties;
contact parties in each subset of parties by different ones of a plurality of contact modes; and
analyze a result of the contacting for each subset of parties to identify a contact mode of the plurality of contact modes for contacting the parties in each cluster of the plurality of clusters that maximizes a probability of achieving the desired outcome.

23. The apparatus of claim 22, wherein the processor unit further executes the program code to form the list of attributes.

24. The apparatus of claim 22, wherein select a subset of parties from each cluster of parties of the plurality of clusters of parties, comprises:
select a random but representative subset of parties from each cluster of parties.

25. The apparatus of claim 22, wherein divide the plurality of parties to be contacted into a plurality of clusters comprises:
change clusters based on the contacting of the plurality of parties in each cluster of the plurality of clusters.
